(19) United States
(12) Patent Application Publication
(10) Pub. No.: US 2009/0244662 A1
(43) Pub. Date: Oct. 1, 2009

(54) IMAGE READING APPARATUS AND IMAGE READING METHOD

(75) Inventors: Hiroaki Kubo, Muko-shi (JP); Nobuhiro Mishima, Osaka-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/332,003

(22) Filed: Dec. 10, 2008

(30) Foreign Application Priority Data
Mar. 28, 2008 (JP) 2008-087848

(51) Int. Cl. H04N 1/46

(52) U.S. Cl. 358/512

(57) ABSTRACT

The present invention aims to avoid problems such as not detecting line-shaped noises or erasing images on the sheet by erroneously detecting line-shaped noises. A copy machine 1 refers to a judgment table 50b to determine a color corresponding to values of RGB color components read in Step S101 (Step S102). The copy machine 1 selects thresholds and coring levels corresponding to matched RGB color components (Step S104). The copy machine 1 sets the selected thresholds and coring levels to an image processing unit 48 (Step S106). The copy machine 1 judges whether a difference between RGB color components of a target pixel and its neighboring pixels is greater than the thresholds that has been set in Step S106 (Step S107). If judging affirmatively, the copy machine 1 stores the address of the target pixel as a line-shaped noise candidate pixel into a line-shaped noise address storing area 49b (Step s108), and extract a series of line-shaped noise candidate pixels as line-shaped noise pixels (Step S110).

### CROSS-REFERENCE TO RELATED APPLICATION

This application is based on an application No. 2008-087848 filed on Mar. 28, 2008 in Japan, the contents of which is hereby incorporated by reference.

### BACKGROUND OF THE INVENTION

(1) Field of the Invention

The present invention relates to an image reading apparatus, and particularly to an image reading apparatus that reads an image from a document sheet while carrying the document sheet over a scanner unit thereof.

(2) Description of the Related Art

A method called the “sheet-through method” has been conventionally used by image reading apparatuses, which are generally provided in, for example, scanners, MFPs (Multi Function Peripherals), copy machines and fax machines. Unlike the “platen-set method”, which carries a scanner unit along a document sheet fixed at a scanning area, the “sheet-through method” carries a document sheet over the scanner unit fixed at the scanning area to scan an image from the document sheet.

By the way, if a foreign object such as dirt and dust is attached to part of the scanning area, the scanner unit might scan the foreign object as well when scanning the document sheet. This results in a noise on the scanned image. In the case of the “platen-set method”, the scanner unit moves away from the foreign object as scanning the document sheet. Accordingly, in many cases, the foreign object causes only a small noise. However, in the case of the “sheet-through method”, the scanner unit keeps scanning the foreign object while the document sheet is being conveyed, because the scanner unit does not move. As a result, this sometimes causes a large noise called “a line-shaped noise”.

Usually, the scanner unit includes a CCD or a CMOS, which has a plurality of elements consisted of RGB channels for reading RGB color components respectively. For example, a foreign object attached to the G channel causes a green line-shaped noise extending in the feeding direction of the document sheet.

To solve this problem, techniques for detecting and removing a series of pixels that is appear to be line-shaped noises have been invented (For example, see Japanese laid-open Patent Application Publications No. 2000-78409, No. 2002-271631, No. 2005-94685, No. 2003-8846 and No. 2004-297302). According to these techniques, the RGB color components of a detected noise are corrected according to the RGB color components of pixels surrounding the noise (hereinafter called “the surrounding pixels”).

In these techniques, if displacement between RGB color components of a target pixel and neighboring pixels of the target pixel is greater than a prescribed value, the target value is considered as a line-shaped noise pixel without any regard for the color of the neighboring pixels. However, a color difference between a line-shaped noise pixel and its neighboring pixels differs depending on the channel to which the foreign object is attached. Accordingly, if the line-shaped noise pixel has a color that is similar to the color of the neighboring pixels and the displacement is not greater than the prescribed value, it might happen that the line-shaped noise pixel can not be detected. Conversely, if an attempt is made to detect a line-shaped noise even though the displacement is small in order to solve this problem, pixels that actually do not form a line-shaped noise might be detected as a line-shaped noise and corrected according to the surrounding pixels. As a result, the original image on the document sheet might be destroyed.

### SUMMARY OF THE INVENTION

The object of the present invention is to provide an image reading apparatus that is capable of avoiding such problems as not detecting line-shaped noises or destroying images on the document sheet by erroneously detecting line-shaped noises.

A first image reading apparatus pertaining to the present invention is an image reading apparatus comprising: a reader operable to read an image formed on a sheet to acquire RGB values of pixels that constitute the image, by using a sheet-through method; a storage that stores therein a plurality of combinations of an RGB value and a condition for line-shaped noise extraction corresponding thereto; an extractor operable to acquire, from the storage, for each target pixel in the image, conditions corresponding to RGB values of surrounding pixels included in a surrounding area of the target pixel, and according to each of the acquired conditions, extract the target pixel as a line-shaped noise pixel if the target pixel constitutes a series of line-shaped noise pixels extending in a feeding direction of the sheet; and a corrector operable to correct an RGB value of the line-shaped noise pixel based on an RGB value of at least one of surrounding pixels included in a surrounding area of the line-shaped noise pixel.

A second image reading apparatus pertaining to the present invention is an image reading apparatus comprising: a reader operable to read an image formed on a sheet to acquire RGB values of pixels that constitute the image, by using a sheet-through method; an extractor operable to compare R, G and B components included in an RGB value of each target pixel in the image with R, G and B components included in an RGB value of a neighboring pixel thereof to judge whether any component has a difference that is no less than a prescribed threshold, and extract the target pixel as a line-shaped noise pixel if at least one of the components has the difference and the line-shaped noise pixel constitutes a prescribed number or more of line-shaped noise pixels extending in a feeding direction of the sheet; a corrector operable to correct the RGB value of the line-shaped noise pixel based on an RGB value of at least one of surrounding pixels included in a surrounding area of the line-shaped noise pixel; and a correction canceller operable to generate color-difference signals based on the RGB value of the line-shaped noise pixel and the RGB values of the surrounding pixels included in the surrounding area of the line-shaped noise pixel respectively, calculate a color-deference level therebetween, and cancel correction of the RGB value of the line-shaped noise pixel if the color-difference level is less than a prescribed level.

A first image reading method pertaining to the present invention is an image reading method comprising: a reading step of reading an image formed on a sheet to acquire RGB values of pixels that constitute the image, by using a sheet-through method; a storing step of storing, in a storage, a plurality of combinations of an RGB value and a condition for line-shaped noise extraction corresponding thereto; an extracting step of acquiring, from the storage, for each target pixel in the image, conditions corresponding to RGB values of surrounding pixels included in a surrounding area of the target pixel, and according to each of the acquired conditions, extracting the target pixel as a line-shaped noise pixel if the target pixel constitutes a series of line-shaped noise pixels extending in a feeding direction of the sheet; and a correcting step of correcting an RGB value of the line-shaped noise pixel based on an RGB value of at least one of surrounding pixels included in a surrounding area of the line-shaped noise pixel.

A second image reading method pertaining to the present invention is an image reading method comprising: a reading step of reading an image formed on a sheet to acquire RGB values of pixels that constitute the image, by using a sheet-through method; an extracting step of comparing R, G and B components included in an RGB value of each target pixel in the image with R, G and B components included in an RGB value of a neighboring pixel thereof to judge whether any component has a difference that is no less than a prescribed threshold, and extracting the target pixel as a line-shaped noise pixel if at least one of the components has the difference and the line-shaped noise pixel constitutes a prescribed number or more of line-shaped noise pixels extending in a feeding direction of the sheet; a correcting step of correcting the RGB value of the line-shaped noise pixel based on an RGB value of at least one of surrounding pixels included in a surrounding area of the line-shaped noise pixel; and a correction canceling step of generating color-difference signals based on the RGB value of the line-shaped noise pixel and the RGB values of the surrounding pixels included in the surrounding area of the line-shaped noise pixel respectively, calculating a color-deference level therebetween, and canceling correction of the RGB value of the line-shaped noise pixel if the color-difference level is less than a prescribed level.

With the stated structure, the first image reading apparatus pertaining to the present invention extracts line-shaped noise pixels using different conditions depending on the color of the pixels in the surrounding area. The conditions are, for example, thresholds for comparing the RGB values with the neighboring pixels to perform the edge detection, coring levels for performing coring on the pixels read by the reader, and so on. With this structure, the image reading apparatus can extract the line-shaped noise pixels using an appropriate condition according to the color of the pixels in the surrounding area by, for example, storing experimentally measured appropriate conditions corresponding to colors of the surrounding area in the storage. This prevents detection failure of the line-shaped noise.

Also, the second image reading apparatus pertaining to the present invention corrects the RGB values of the line-shaped noise pixel by replacing with the RGB values of the block included in the surrounding area only when there is a difference between the color difference of the line-shaped noise pixel and the RGB values of the block included in the surrounding area to be used for correction of the line-shaped noise pixel. In other words, since the correction does not make a significant change when there is no such a color difference, the image reading apparatus does not perform correction in such a case to prevent misdetection of the line-shaped noise pixels and unintended correction of the pixels. Appropriate levels for the color difference may be prescribed by performing experimental measurement in advance.

Regarding the first image reading apparatus, each of the conditions may indicate thresholds for R, G and B components included in a corresponding RGB value, and the extractor may compare R, G and B components included in the RGB value of the target pixel with R, G and B components included in an RGB value of a neighboring pixel thereof to judge whether any component has a difference that is no less than corresponding one of the thresholds indicated by conditions corresponding to the RGB values of the surrounding pixels included in the surrounding area of the target pixel, and extract the target pixel as the line-shaped noise pixel if at least one of the components has the difference and a count of the series of line-shaped noise pixels is no less than a prescribed number.

With the stated structure, the image reading apparatus extracts the line-shaped noise pixels using an appropriate threshold according to the color of the pixels in the surrounding area. As a result, the image reading apparatus can prevent detection failure of the line-shaped noise.

Regarding the first image reading apparatus, each of the conditions may indicate a coring level for coring, and the extractor may perform the coring on the RGB values of the pixels acquired by the reader, according to the coring level indicated by the conditions corresponding to the RGB values of the surrounding pixels included in the surrounding area of the target pixel, compare coring-result R, G and B components included in the RGB value of the target pixel with coring-result R, G and B components included in an RGB value of a neighboring pixel thereof to judge whether any component has a difference that is no less than a prescribed threshold, and extract the target pixel as the line-shaped noise pixel if at least one of the components has the difference and a count of the series of line-shaped noise pixels is no less than a prescribed number.

With the stated structure, the image reading apparatus performs the coring on the pixels using an appropriate coring level according to the color of the pixels in the surrounding area. As a result, the image reading apparatus can prevent detection failure of the line-shaped noise.

Regarding the first image reading apparatus, each of the conditions may indicate thresholds for R, G and B components included in a corresponding RGB value, and a coring level for coring, and the extractor may perform the coring on the RGB values of the pixels acquired by the reader, according to the coring level indicated by the conditions corresponding to the RGB values of the surrounding pixels included in the surrounding area of the target pixel, compare coring-result R, G and B components included in the RGB value of the target pixel with coring-result R, G and B components included in an RGB value of a neighboring pixel thereof to judge whether any component has a difference that is no less than corresponding one of the thresholds indicated by conditions corresponding to the RGB values of the surrounding pixels included in the surrounding area of the target pixel, and extract the target pixel as the line-shaped noise pixel if at least one of the components has the difference and a count of the series of line-shaped noise pixels is no less than a prescribed number.

With the stated structure, the image reading apparatus performs the coring on the pixels using an appropriate coring level according to the color of the pixels in the surrounding area, and also extracts the line-shaped noise pixels using an appropriate threshold according to the color of the pixels in the surrounding area. As a result, the image reading apparatus can prevent detection failure of the line-shaped noise.

Regarding the first image reading apparatus, the corrector may define a plurality of blocks throughout the surrounding area of the line-shaped noise pixel by averaging R, G and B components among each prescribed number of pixels, extract one of the blocks whose non-noise color component has a smallest difference from a non-noise color component of the line-shaped noise pixel, and correct the RGB value of the line-shaped noise pixel by replacing with an RGB value of the extracted one of the blocks, where the non-noise color component is any component of the RGB value of the line-shaped noise pixel other than a noise color component, and the noise color component is a component that has the difference that is no less than the corresponding one of the thresholds indicated by the conditions corresponding to the RGB values of the surrounding pixels included in the surrounding area of the line-shaped noise pixel.

With the stated structure, the image reading apparatus corrects the RGB color components of the line-shaped noise in units of blocks obtained by averaging the RGB color components of the pixels in the surrounding area. As a result, the image reading apparatus can perform the smoothing correction.

Regarding the first image reading apparatus, the corrector may generate color-difference signals based on the RGB value of the line-shaped noise pixel and the RGB values of the surrounding pixels included in the surrounding area of the line-shaped noise pixel respectively, calculate a color-deference level therebetween, and cancel correction of the RGB value of the target pixel if the color-difference level is less than a prescribed level.

With the stated structure, the image reading apparatus corrects the RGB values of the line-shaped noise pixel by replacing with the RGB values of the block included in the surrounding area only when there is a difference between the color difference of the line-shaped noise pixel and the RGB values of the block included in the surrounding area to be used for correction of the line-shaped noise pixel. In other words, since the correction does not make a significant change when there is no such a color difference, the image reading apparatus does not perform correction in such a case to prevent misdetection of the line-shaped noise pixels and unintended correction of the pixels.

### BRIEF DESCRIPTION OF THE DRAWINGS

These and the other objects, advantages and features of the invention will become apparent from the following description thereof taken in conjunction, with the accompanying drawings which illustrate a specific embodiment of the invention.

In the drawings:

FIG. 1 schematically shows the structure of a copy machine 1 pertaining to an embodiment of the present invention;

FIG. 2 is a block diagram showing the structure of a control unit 46 of the copy machine 1;

FIG. 3 is a functional block diagram pertaining to image scanning and image processing;

FIG. 4 is a functional block diagram pertaining to line-shaped noise extraction (500);

FIG. 5 is a functional block diagram pertaining to line-shaped noise correction (600);

FIG. 6A and FIG. 6B show surrounding areas and block areas respectively;

FIG. 7 shows a judgment table 50b;

FIG. 8 is a flowchart showing line-shaped noise pixel extraction performed by the copy machine 1; and

FIG. 9 is a flowchart showing line-shaped noise pixel correction performed by the copy machine 1.

### DESCRIPTION OF THE PREFERRED EMBODIMENT

The following explains an embodiment of the present invention with reference to the drawings.

In the following explanations, a case where the image reading apparatus pertaining to the present invention is applied to a digital color copy machine (hereinafter simply referred to as “a copy machine”) is taken as an example.

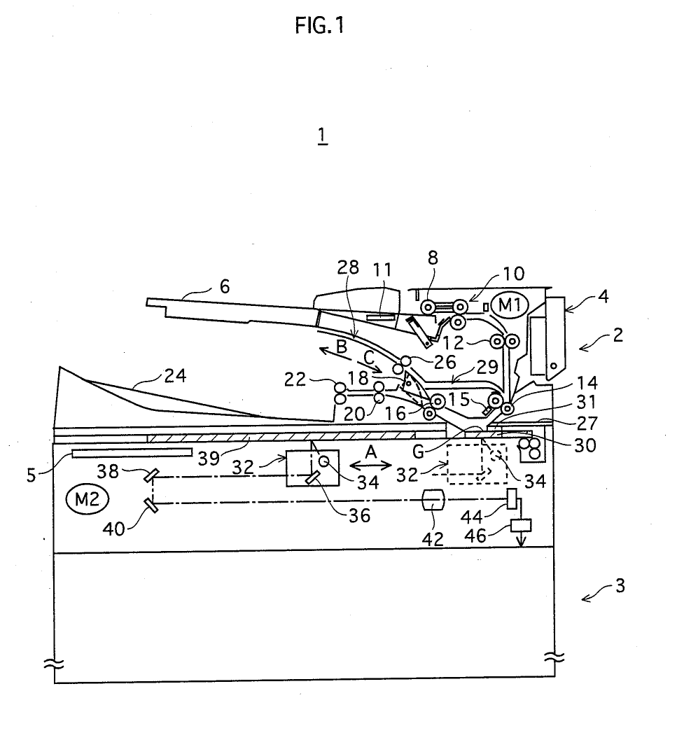

FIG. 1 schematically shows the structure of a copy, machine 1.

As FIG. 1 shows, the copy machine 1 basically consists of a scanner unit 2 as an image reading apparatus for reading images on a document sheet, and a printer unit 3 for printing the read images on a recording sheet to duplicate the images.

The scanner unit 2 is structured such that the sheet-through method as one of fixed optical systems and the platen-set method as one of movable optical systems are both available for scanning images. Here, the sheet-through method is a method for scanning images while moving a document sheet in the state where the optical system is stopped (fixed). The platen-set method is a method for scanning images while moving a mirror for reflecting light from the document sheet surface to the CCD sensor in the state where the document sheet is fixed. Here, the light path length from the document sheet scanning area to the CCD sensor is constant.

The scanner unit 2 is equipped with a document feeder 4 for enabling the sheet-through method. The document feeder 4 is for carrying document sheets in a document input tray 6 one by one to a document output tray 24 via a scanning area G on a platen glass 30 as a translucent member. In other words, the document feeder 4 serves as means for conveying document sheets. Here, it is assumed that the copy machine 1 is capable of switching between two modes, namely a single scan mode for scanning only a single side of each document sheet, and a double scanning mode for reversing document sheets and sequentially scanning both sides (the front face and the reverse side) of each document sheet.

In the single scan mode, the uppermost sheet among the document sheets in the document input tray 6 is separated from the document sheets by a pick up roller 8 and a separation roller 10 and conveyed to a resist roller pair 14 via a first intermediate roller pair 12. The sheet's skew is corrected here, and the document sheet is next conveyed to the platen glass 30 by the resist roller pair 14. The images on the document sheet are scanned while the document sheet is being moved through the scanning area G on the sheet-through platen glass 30. The document sheet that has passed over the platen glass 30 is conveyed to an ejection roller pair 22 by a second intermediate roller pair 16 and a third immediate roller pair 20, and ejected to the document output tray 24 by the ejection roller 22.

On the other hand, in the double scan mode, a switching hook 18 is moved to the position illustrated in dashed line in FIG. 1 before scanning of the front face of a document sheet. Upon scanning of the front face, the document sheet is conveyed from the second intermediate roller pair 16 to a fourth intermediate roller pair 26 via the switching hook 18, and conveyed on a paper path 28 by the fourth intermediate roller pair 26 in the direction indicated by an arrow B. When the vicinity of the rear end of the document sheet reaches the fourth intermediate roller pair 26, the fourth intermediate roller pair 26 rotates in the opposite direction, and the switching hook 18 is moved to the position illustrated in full line in FIG. 1.

As a result, the document sheet, whose front face has been scanned, is switched back on the paper path 28 in the direction indicated by an arrow C. The document sheet is conveyed to a paper path 29 via the switching hook 18 with the above-mentioned rear end in the lead, and conveyed to the resist roller pair 14 again. Then, the document sheet is conveyed to the platen glass 30 by the resist roller pair 14. At this moment, the reverse side of the document sheet faces the front face of the platen glass 30. The reverse side of the document sheet is scanned while the document sheet is being moved through the scanning area G. After that, the document sheet is ejected to the document output tray 24 via the second intermediate roller pair 16, the third intermediate roller pair 20 and the ejection roller 22.

Each of the rollers described above is driven and rotated by a motor M1 via a power transmission mechanism and so on (not illustrated). Also, a document resist sensor 15 is provided at a position downstream the resist roller pair 14 in terms of the feeding direction of the document sheet. The document resist sensor 15 detects the front end and the rear end of each of conveyed document sheets. Further, a document size detection sensor 11 is provided on the document input tray 6. The document size detection sensor 11 detects a size of a document sheet that has been set in the document input tray 6.

The document sheet that passes over the sheet-through platen glass 30 is irradiated by a light source 34 of a scanner 32 that remains stationary under the platen glass 30. The path of the light reflected from the document sheet surface is changed by a first mirror 36, a second mirror 38 and a third mirror 40. A condenser lens 42, which receives the light, forms an image on a CCD sensor 44. The CCD sensor 44 performs photoelectric conversion to generate image signals. As a result, image data that shows RGB color components is generated from the image signals. The generated image data is subjected to image processing performed by a control unit 46, and sent to the printer unit 3.

The printer unit 3 is an image formation apparatus that is based on a well-known electrophotographic system. The printer unit 3 forms (prints) document images on a recording sheet, based on the image data received from the control unit 46.

In addition to the sheet-through platen glass 30, the copy machine 1 is equipped with a platen glass 39 for manual setting. As described above, when scanning a document sheet by the sheet-through method, the scanner 32 is moved to the position under the sheet-through platen glass 30 as illustrated in dashed line, and at this position, irradiates the document sheet conveyed by the document feeder 4, to scan images on the document sheet.

On the other hand, when scanning a document sheet manually placed on the manual-setting platen glass 39 (i.e. when scanning the document sheet by the platen-set method), the document feeder 4 is opened upward, and the document sheet is placed on the manual-setting platen glass 39.

In the state where the document sheet is placed, the scanner 32 is moved in the directions indicated by an arrow A shown in FIG. 1. In this regard, the second mirror 38 and the third mirror 40 move as a pair in the same direction as the scanner 32 at half the speed as the scanner 32. As a result, the distance (light path length) between the document sheet surface and the condenser lens 42 is always kept constant, and the light reflected from the document sheet forms an image on the light-reception surface of the CCD sensor 44. Note that the scanner 32, the second mirror 38, and the third mirror 40 are driven by a motor M2 via a power transmission mechanism and soon (not illustrated).

Also, an operation panel 5 is provided on the top face of the copy machine 1 at a position where users can easily operate. The operation panel 5 includes a numeric keypad for setting a number of copies, and keys for switching between the double scanning mode and the single scanning mode and between high-resolution scanning and low-resolution scanning, and so on. Also, a key for switching between an unmixed-loading mode and a mixed-loading mode is provided. The unmixed-loading mode is for feeding and scanning document sheets one by one from a document stack consisted of only one size. The mixed-loading mode is for feeding and scanning document sheets one by one from a document stack consisted of different sizes, such as A3 sheets (in the portrait orientation) and A4 sheets (in the landscape orientation). The user can switch between the modes by pressing each of the keys.

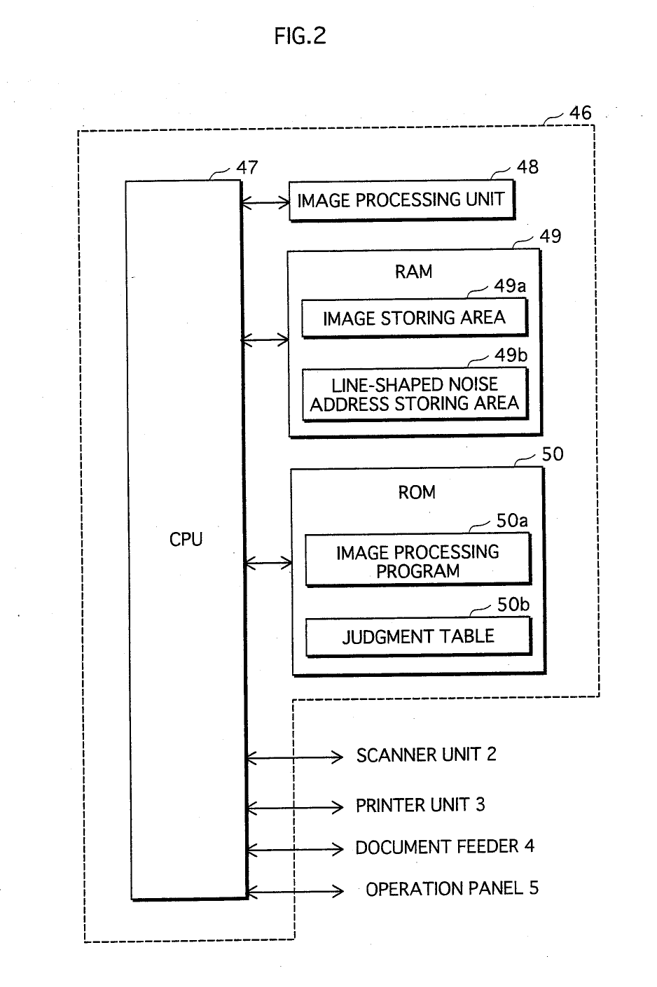

FIG. 2 is a block diagram showing the structure of the control unit 46.

As FIG. 2 shows, the control unit 46 mainly includes a CPU (Central Processing Unit) 47, an image processing unit 48, a RAM (Random Access Memory) 49, and a ROM (Read Only Memory) 50.

The image processing unit 48 processes the image data received from the CCD sensor 44 as described later, and stores the processed image data in an image storing area 49a of the RAM 49. The image data stored in the image storing area 49a is read out at printing such as copying.

The RAM 49 is a rewritable memory, and stores, for example, data required for the scanner unit 2 to perform processing. In particular, the RAM 49 includes an image storing area 49a and a line-shaped noise address storing area 49b. The image storing area 49a is for storing image data generated by the scanner unit 2. The line-shaped noise address storing area 49b is for storing addresses of the line-shaped noise pixels used at line-shaped noise detection performed by the scanner unit 2 as described later.

The ROM 50 is a non-rewritable memory, and stores image processing program 50a for controlling the image processing unit 48 and a judgment table 50b described later.

### 2. Judgment Table

The following describes the judgment table 50b stored in the ROM 50.

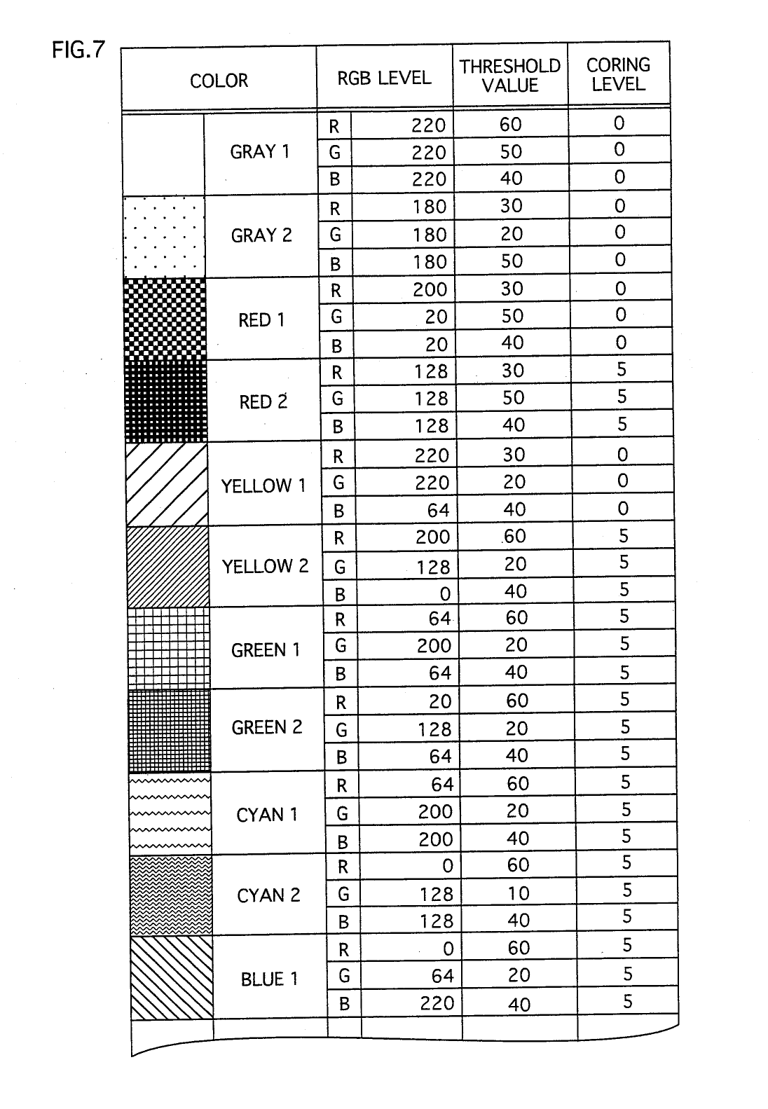

FIG. 7 shows the judgment table 50b.

The judgment table 50b is a table for determining a color of a pixel according to values of the RGB color components, and a threshold for line-shaped noise extraction and a coring level according to the values of the RGB color components.

The color of the pixel, the thresholds for the line-shaped noise extraction and the coring levels are determined based on the values (color densities) of the RGB color components.

Note that the values of the RGB color components have an upper range and a lower range (20 for each).

For example, when the R component is in a range of 200 to 240, the G component is in a range of 200 to 240 and the B component is in a range of 200 to 240, the color of the pixel is determined as gray 1. Accordingly, the threshold for the R component is determined as 60, the threshold for the G component is determined as 50, and the threshold for the B component is determined as 40. Also, the coring level is determined as 0 for each of the R, G and B components.

When the R component is in a range of 0 to 40, the G component is in a range of 108 to 148 and the B component is in a range of 44 to 84, the color of the pixel is determined as green 2. Accordingly, the threshold for the R component is determined as 60, the threshold for the G component is determined as 20, and the threshold for the B component is determined as 40. Also, the coring level is determined as 5 for each of the R, G and B components.

The thresholds for line-shaped noise extraction are used for judging whether a target pixel is a line-shaped noise pixel or not by comparing the RGB color components of the target pixel and the surrounding pixels respectively. For example, when the surrounding pixels are of the gray 1 color, if the difference between the target pixel and the surrounding pixels satisfies at least one of the following conditions, the target pixel is to be extracted as a pixel of a line-shaped noise pixel: The first condition is that the difference is no less than 60 as to the R components; The second condition is that the difference is no less than 50 as to the G components; and the third condition is that the difference is no less than 40 as to the B components.

A value of the coring level shows a level at which coring is performed on the target pixel. The coring is processing for restrict components having small absolute values from passing through. Here, the coring is filtering processing by which components smaller than the coring level are regarded as “0”. For example, when the surrounding pixels are of the green 2 color, any of components of the target pixel smaller than 5 are regarded as “0”.

Note that the thresholds for the line-shaped noise extraction and the coring levels for each color may be appropriately determined according to experimental measurement, for example.

### 3. Image Processing

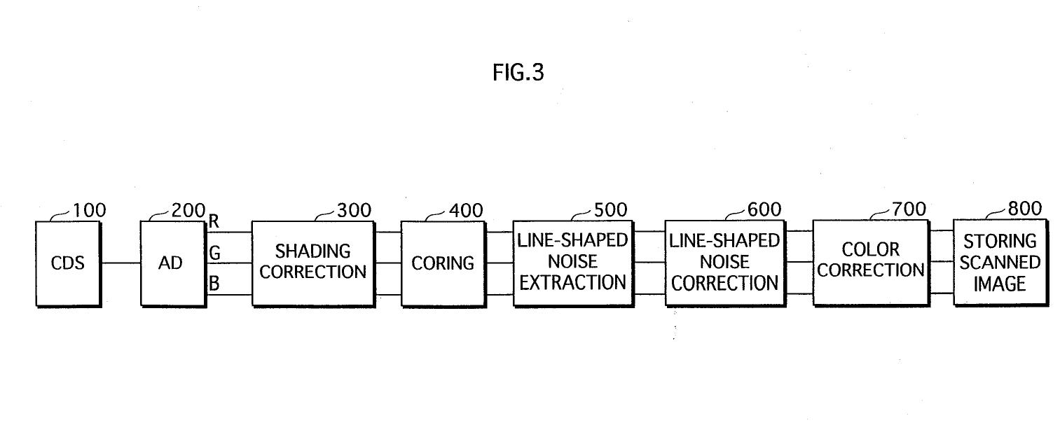

The following explains image processing performed by the image processing unit 48 on the image scanned by the scanner unit 2, with reference to FIG. 3 to FIG. 5.

FIG. 3 is a functional block diagram pertaining to image scanning and image processing.

In the scanner unit 2, the image output from the CCD 44 is subjected to CDS (Correlated Double Sampling) processing (100) in order to remove amplification noises and reset noises, subjected to A/D (Analogue to Digital) conversion (200), and sent to the image processing unit 48, as image data showing RGB color components.

In the image processing unit 48, the RGB color components are subjected to shading correction (300) in order to improve evenness in the brightness, and also subjected to coring (400), which is filtering for regarding RGB color components smaller than a prescribed level as “0”. Further, line-shaped noise extraction (500) and line-shaped noise correction (600) are performed in order to remove line-shaped noises. Finally, color correction (700) is performed to correct the contrast and the tint. After that, the RGB color components are stored in the RAM (800).

### 3-1. Line-Shaped Noise Extraction

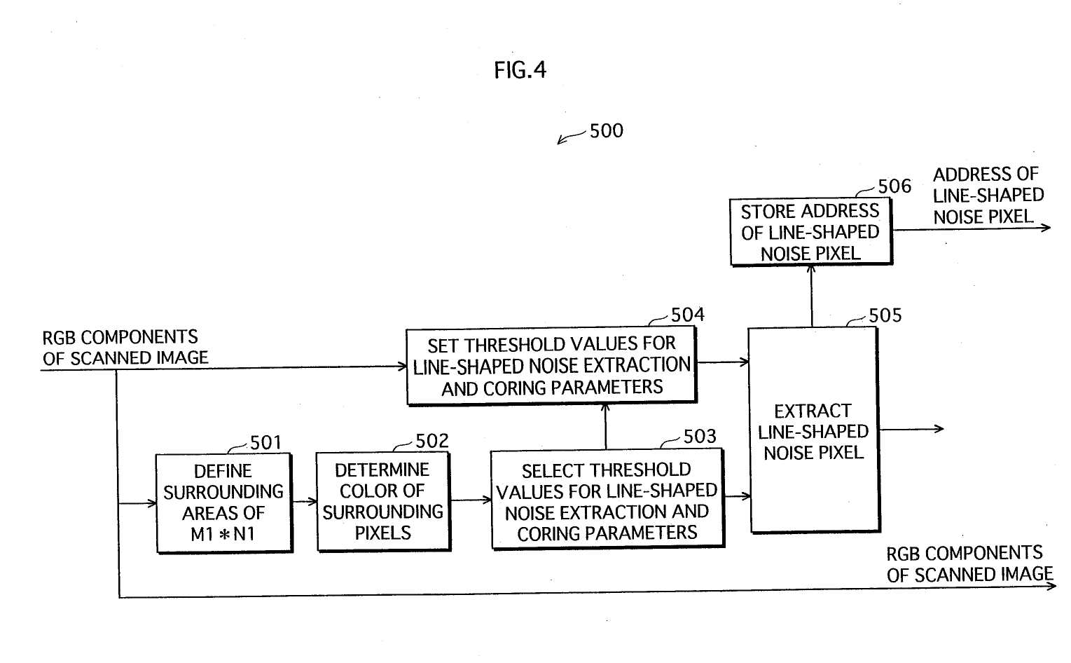

FIG. 4 is a functional block diagram pertaining to the line-shaped noise extraction (500).

Upon receiving image data from the scanner unit 2, the image processing unit 48 sequentially chooses a pixel as the target pixel P one by one, and defines two surrounding areas, each consisted of M1*N1 pixels, around each target pixel P (501).

The image processing unit 48 averages the RGB color components of the surrounding pixels and judges the color of the surrounding pixels based on the averaged RGB color components and the judgment table 50b (502). Also, the image processing unit 48 selects thresholds for the line-shaped noise extraction and coring levels according to the judgment result color (503), and sets the thresholds and the coring levels (504).

If the difference between the target pixel P and the neighboring pixels is greater than the threshold regarding any of the RGB color components, the image processing unit 48 regards this target pixel P as a line-shaped noise candidate pixel. Further, regarding at least one of the R component, the G component and B component, if the number of consecutive line-shaped noise candidate pixels is not less than a prescribed number, the image processing unit 48 extracts the line-shaped noise candidate pixels as line-shaped noise pixels (505), and stores the addresses of the pixels in the noise address storing area 49b (506). Here, for comparison between the RGB color components of the target pixel P and the RGB color components of the neighboring pixels, an edge detection method based on displacement between the pixels is used. This method is commonly used in the technical field of image processing.

Note that the component to which a foreign object is attached, which causes the line-shaped noise, is called a “noise-color component”, and the other components are called “non-noise color components”.

According to the stated processing, the image processing unit 48 determines line-shaped noise pixels.

### 3-2. Line-Shaped Noise Correction

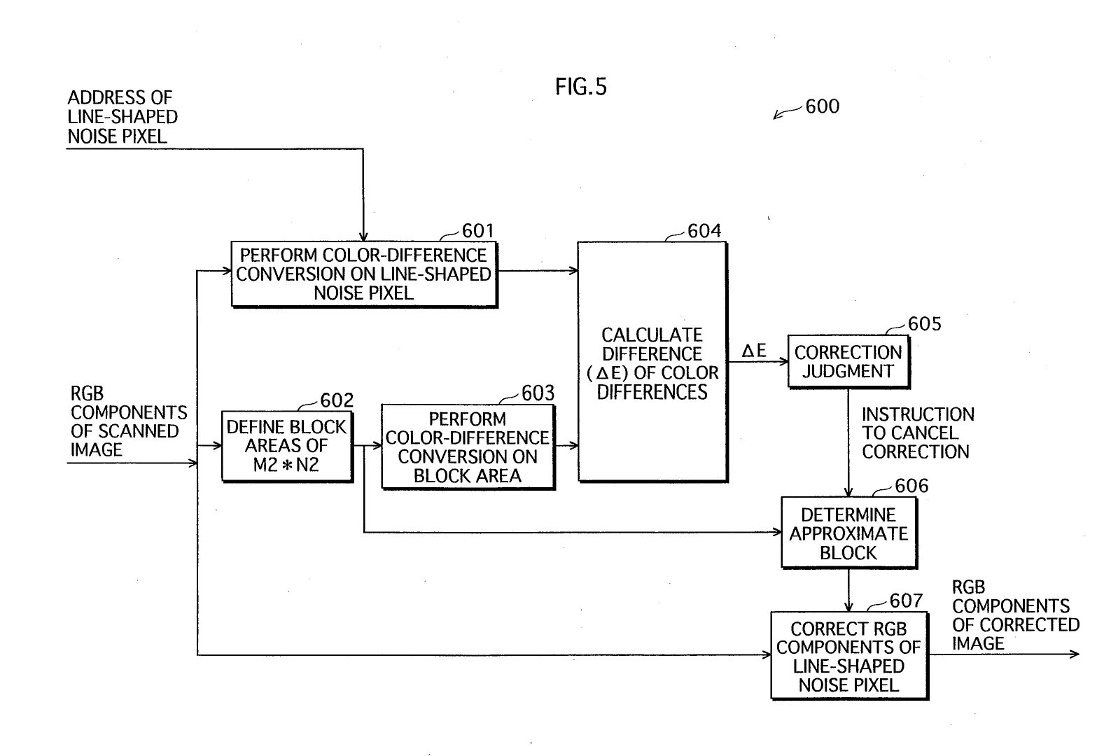

Next, FIG. 5 is a functional block diagram pertaining to the line-shaped noise correction (600).

The image processing unit 48 chooses a target pixel P one by one from the line-shaped noise pixels shown by the addresses stored in the line-shaped noise address storing area 49b, and converts the selected target pixel P to color-difference signals (601). The color-difference signals Cr and Cb can be obtained by the following formula 1, where the R component, the G component, and the B component of the target pixel P are R, G, and B respectively:

Cr=(0.7*R−0.59*G−0.11*B)/1.4

Cb=(−0.3*R−0.59*G+0.89*B)/1.78 (Formula 1)

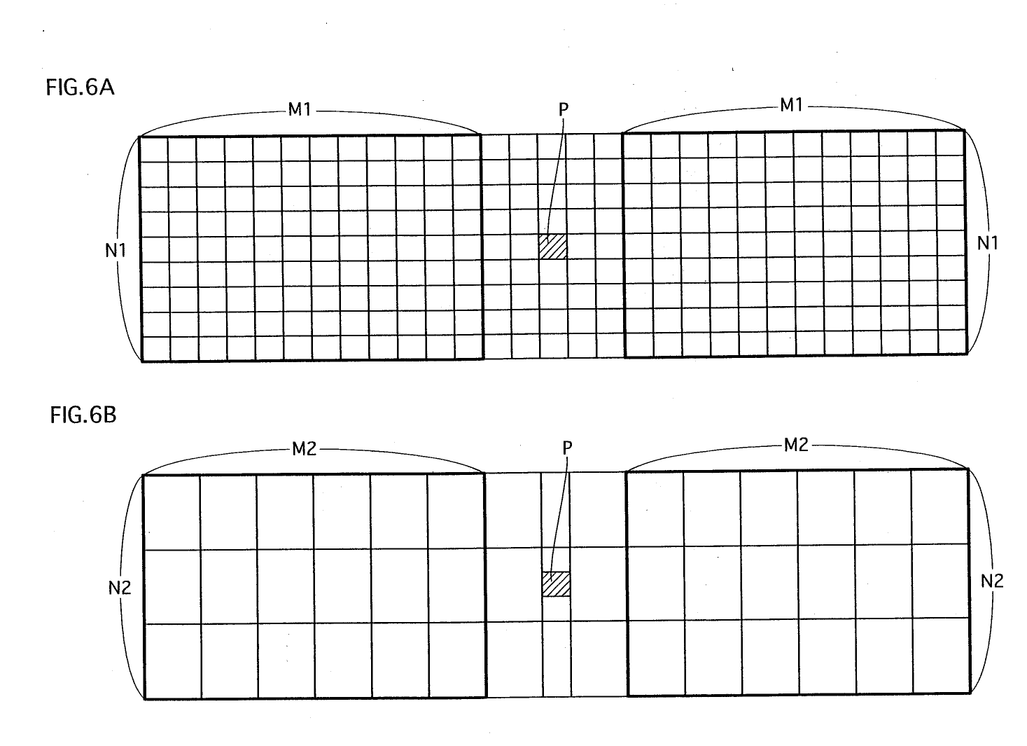

Also, as FIG. 6B shows, the image processing unit 48 combines a plurality of neighboring pixels around the target pixel P (for example, each 2*3 pixels as shown in FIG. 6B), and averages each of RGB color components of the pixels included in each group to define block areas each consisted of M2*N2 blocks (for example, 6*3 blocks in FIG. 6B) (602). The image processing unit 48 also converts the averaged RGB color components obtained by averaging the RGB color components of the block areas to color-difference signals (603). The color-difference signals BKCr and BKCb can be obtained by the following formula 2, where the R component, the G component, and the B component of the block area are R_BKAV, G_BKAV, and B_BKAV respectively:

BKCr=(0.7*R_{—}BKAV−0.59*G_{—}BKAV−0.11*B_{—}BKAV)/1.4

BKCb=(−0.3*R_{—}BKAV−0.59*G_{—}BKAV+0.89*B_{—}BKAV)/1.78 (Formula 2)

Also, the image processing unit 48 determines, as an approximate block, a block whose non-noise color components have values (densities) that are closest in the block area to the corresponding components of the target pixel P (606). The image processing unit 48 corrects the RGB color components of the target pixel P according to the RGB color components of the approximate block (607).

On the other hand, the image processing unit 48 calculates a color difference [symbol] E between the target pixel P and the surrounding pixels, based on the color-difference signals of the target pixel P and the color-difference signals of the averaged RGB color components (604). The difference [symbol] E can be obtained by the following formula using Cr, Cb, BKCr and BKCb.

[symbol]

E=((Cr−BKCr)²+(Cb−BKCb)²)^{1/2} (Formula 3)

If the difference [symbol] E is not more than a prescribed value Ref 1, the image processing unit 48 cancels correction of the RGB color components of the target pixel P (605). This is because if the difference between the color difference of the target pixel P and the color difference of the block area is small, they are similar colors and do not form a distinct line-shaped noise even though the correction of the target pixel P is not performed. The prescribed value Ref 1 indicates that the difference [symbol] E can be judged as substantially “0” (i.e. there is no difference). The prescribed value Ref 1 may have been appropriately determined according to experimental measurement.

### 4. Operations

The following explains flows of the line-shaped noise extraction and the line-shaped noise correction performed by the image processing unit 48 executing the image processing program 50a.

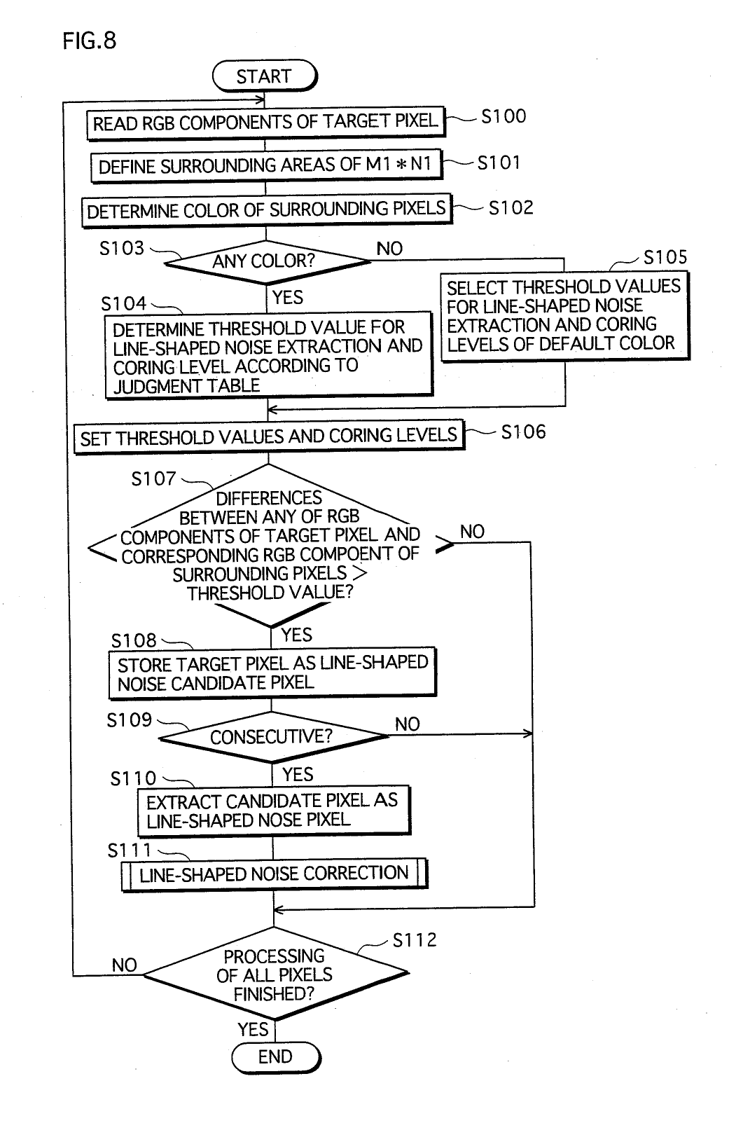

FIG. 8 is a flowchart showing the line-shaped noise extraction.

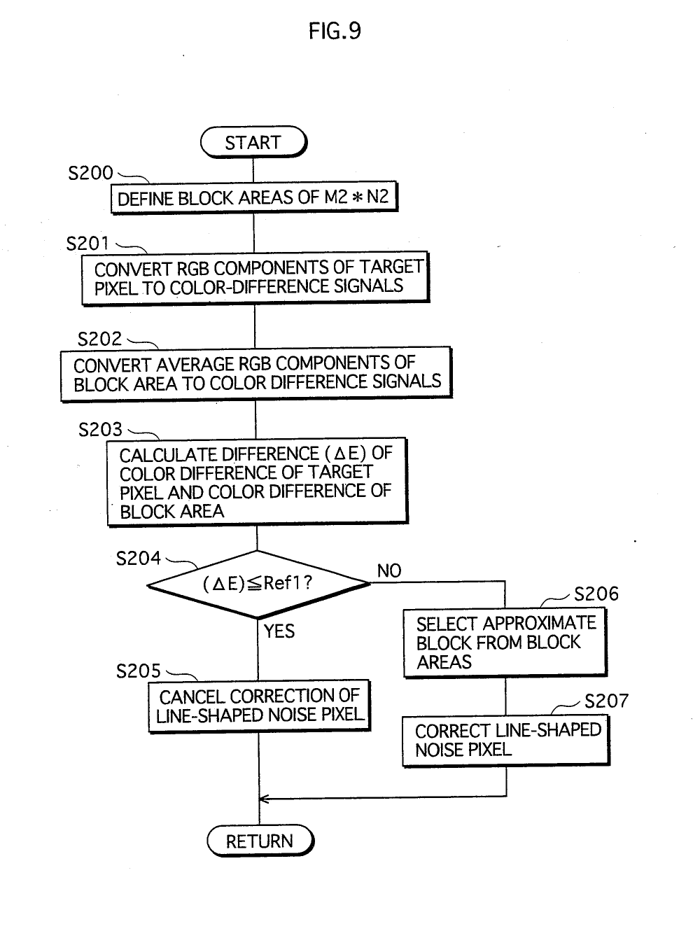

FIG. 9 is a flowchart showing the line-shaped noise correction.

### 4-1. Line-Shaped Noise Extraction

As FIG. 8 shows, the image processing unit 48 reads the RGB color components (density) of the target pixel (Step S100), and defines surrounding areas, each consisted of M1*N1 pixels, around the target pixel (Step S101).

The image processing unit 48 refers to the judgment table 50b, and determines a color corresponding to the RGB color components of the surrounding pixels defined in Step S101 (Step S102).

If the color determined in Step S102 does not match with any color in the judgment table 50b (Step S103: NO), the image processing unit 48 selects the threshold for the line-shaped noise extraction and the coring level of a default color (gray 1) (Step S105).

If the color determined in Step S102 matches with any color in the judgment table 50b (Step S103: YES), the image processing unit 48 selects a threshold for the line-shaped noise extraction and a coring level corresponding to the matched RGB color components (Step S104).

The image processing unit 48 sets the selected threshold for the line-shaped noise extraction and the selected coring level to the image processing unit 48 (Step S106).

The image processing unit 48 judges, as to each of the RGB color components of the target pixel, whether the difference from the corresponding one of the RGB color components of the surrounding pixels is larger than its corresponding threshold that has been set in Step S106 (Step S107). If at least one of the components is greater than the threshold, the image processing unit 48 stores the address of the target pixel as a line-shaped noise candidate pixel in the line-shaped noise address storing area 49b (Step S108).

If the number of the line-shaped noise candidate pixels stored in the line-shaped noise address storing unit 49b is not less than a prescribed number (Step S109: YES), the image processing unit 48 extracts, as line-shaped noise pixels, the line-shaped noise pixel candidates at least one of whose R components, G components and B components are consecutive (Step S110), and moves to the processing of the line-shaped noise pixel correction (Step S111).

If there are no consecutive line-shaped noise candidate pixels (Step S109: NO), the image processing unit 48 does not extract the candidate pixels as the line-shaped noses.

Upon performing Steps S110 to S111 for all the pixels read by a line sensor 105 (Step S112: YES), the image processing unit 48 finishes the processing procedure.

### 4-2. Line-Shaped Noise Correction

As FIG. 9 shows, for the line-shaped noise correction, the image processing unit 48 averages RGB color components of each of the surrounding pixels (e.g. each 2*3 pixels in FIG. 6B) included in the M1*N1 surrounding pixels around the target pixel, to define a block areas consisted of M2*N2 blocks (e.g. 6*3 blocks in FIG. 6B) (Step S200).

The image processing unit 48 converts the target pixel to a color-difference signals (Step S201), and at the same time, converts the averaged RGB color components of each block area, obtained by averaging the RGB color components of each block area, to color-difference signals (Step S202).

The image processing unit 48 obtains the color difference [symbol] E between the color-difference signals obtained in Step 201 and the color-difference signals obtained in Step S202 (Step S203). If the difference [symbol] E is not greater than the prescribed threshold Ref1 (Step S204: YES), the image processing unit 48 cancels the line-shaped noise correction of the target pixel (Step S205).

If the difference [symbol] E is greater than the prescribed threshold Ref1 (Step S204: NO), the image processing unit 48 determines, as an approximate block, a block whose non-noise color components have values (densities) that are closest in the block areas to the non-noise color components of the target pixel (Step S206). The image processing unit 48 corrects the RGB color components of the target pixel according to the RGB color components of the approximate block (Step S207).

As described above, due to the line-shaped noise extraction and the line-shaped noise correction performed by the image processing unit 48, the copy machine 1 can extracts, a line-shaped noise pixels with use of an appropriate threshold for the line-shaped noise extraction and an appropriate coring level, according to the color of the surrounding pixels of each target pixel. As a result, it is possible to prevent that line-shaped noises are not detected.

Here, the following are supplemental explanations for the coring. As FIG. 3 shows, the coring is performed before the line-shaped noise extraction. Accordingly, the coring level set in Step S106 according to a certain target pixel (i.e. a first target pixel) is used for the coring for the next target pixel (i.e. a second target pixel). This means that the coring level determined according to the surrounding pixels of the first target pixel is not used for the coring of the first target pixel. However in many cases, within an image, the second target pixel next to the first target pixel can be assumed to have the surrounding pixels having substantially the same color. Accordingly, the coring for the first target pixel contributes to prevention of the detection failure and the misdetection of the line-shaped noise regarding the second target pixel. The relation between the first target pixel and the second target pixel is applicable to almost all the pixels included in the image. Therefore, as a whole, the processing for determining the coring level according to the color of the surrounding pixels at the time of the line-shaped noise extraction contributes to the prevention of the detection failure and the misdetection of the line-shaped noise.

Also, the copy machine 1 can detect a line-shaped noise on a high color-intensity document sheet even though it is difficult. Also, regarding the contrast, it is possible to prevent the misdetection and realize detection according to visual sensitivity by increasing the detection sensitivity in the case of noticeable color combinations between the document image and the line-shaped noise, and decreasing the thresholds for the line-shaped noise extraction in the case of not noticeable color combinations.

### (4) Supplemental Explanations

(1) As described above, the copy machine 1 has a structure for extracting line-shaped noise pixels using different thresholds and coring levels according to the color of the surrounding pixels (Steps S100-S112). However, for simplifying the structure more, it is possible to use fixed thresholds and coring levels, regardless of the color of the surrounding pixels.

If this is the case, the copy machine 1 can not prevent undetected line-shaped noises and misdetection of line-shaped noises. However, it is possible to prevent unintentional correction due to misdetection of line-shaped noises by performing the line-shaped noise correction (Steps S200-S207).

(2) The present invention is particularly effective for a sheet-through type image reading apparatus. However, the present invention is applicable to a platen-set type image reading apparatus.

(3) The image processing program 50a may be recorded on and manufactured and distributed in the form of a magnetic tape, a magnetic disk such as a flexible disk, an optical recording medium such as a DVD-ROM, DVD-R, DVD+R, a DVD-RAM, a DVD-RW, a DVD+RW, a CD-ROM, a CD-R, a CD-RW, an MO and a PD, a flash memory type recording medium, and various types of computer readable recording medium. Also, the image processing program 40a may be transmitted via a network such as the Internet, broadcasting, a telecommunication network, and a satellite communications.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An image reading apparatus comprising:
a reader operable to read an image formed on a sheet to acquire RGB values of pixels that constitute the image, by using a sheet-through method;
a storage that stores therein a plurality of combinations of an RGB value and a condition for line-shaped noise extraction corresponding thereto;
an extractor operable to acquire, from the storage, for each target pixel in the image, conditions corresponding to RGB values of surrounding pixels included in a surrounding area of the target pixel, and according to each of the acquired conditions, extract the target pixel as a line-shaped noise pixel if the target pixel constitutes a series of line-shaped noise pixels extending in a feeding direction of the sheet; and
a corrector operable to correct an RGB value of the line-shaped noise pixel based on an RGB value of at least one of surrounding pixels included in a surrounding area of the line-shaped noise pixel.

2. The image reading apparatus of claim 1, wherein
each of the conditions indicates thresholds for R, G and B components included in a corresponding RGB value, and
the extractor compares R, G and B components included in the RGB value of the target pixel with R, G and B components included in an RGB value of a neighboring pixel thereof to judge whether any component has a difference that is no less than corresponding one of the thresholds indicated by conditions corresponding to the RGB values of the surrounding pixels included in the surrounding area of the target pixel, and extracts the target pixel as the line-shaped noise pixel if at least one of the components has the difference and a count of the series of line-shaped noise pixels is no less than a prescribed number.

3. The image reading apparatus of claim 1, wherein
each of the conditions indicates a coring level for coring, and
the extractor performs, the coring on the RGB values of the pixels acquired by the reader, according to the coring level indicated by the conditions corresponding to the RGB values of the surrounding pixels included in the surrounding area of the target pixel, compares coring-result R, G and B components included in the RGB value of the target pixel with coring-result R, G and B components included in an RGB value of a neighboring pixel thereof to judge whether any component has a difference that is no less than a prescribed threshold, and extracts the target pixel as the line-shaped noise pixel if at least one of the components has the difference and a count of the series of line-shaped noise pixels is no less than a prescribed number.

4. The image reading apparatus of claim 1, wherein
each of the conditions indicates thresholds for R, G and B components included in a corresponding RGB value, and a coring level for coring, and
the extractor performs the coring on the RGB values of the pixels acquired by the reader, according to the coring level indicated by the conditions corresponding to the RGB values of the surrounding pixels included in the surrounding area of the target pixel, compares coring-result R, G and B components included in the RGB value of the target pixel with coring-result R, G and B components included in an RGB value of a neighboring pixel thereof to judge whether any component has a difference that is no less than corresponding one of the thresholds indicated by conditions corresponding to the RGB values of the surrounding pixels included in the surrounding area of the target pixel, and extracts the target pixel as the line-shaped noise pixel if at least one of the components has the difference and a count of the series of line-shaped noise pixels is no less than a prescribed number.

5. The image reading apparatus of claim 2, wherein
the corrector defines a plurality of blocks throughout the surrounding area of the line-shaped noise pixel by averaging R, G and B components among each prescribed number of pixels, extracts one of the blocks whose non-noise color component has a smallest difference from a non-noise color component of the line-shaped noise pixel, and corrects the RGB value of the line-shaped noise pixel by replacing with an RGB value of the extracted one of the blocks, where the non-noise color component is any component of the RGB value of the line-shaped noise pixel other than a noise color component, and the noise color component is a component that has the difference that is no less than the corresponding one of the thresholds indicated by the conditions corresponding to the RGB values of the surrounding pixels included in the surrounding area of the line-shaped noise pixel.

6. The image reading apparatus of claim 1, wherein
the corrector generates color-difference signals based on the RGB value of the line-shaped noise pixel and the RGB values of the surrounding pixels included in the surrounding area of the line-shaped noise pixel respectively, calculates a color-deference level therebetween, and cancels correction of the RGB value of the target pixel if the color-difference level is less than a prescribed level.

7. An image reading apparatus comprising:
a reader operable to read an image formed on a sheet to acquire RGB values of pixels that constitute the image, by using a sheet-through method;
an extractor operable to compare R, G and B components included in an RGB value of each target pixel in the image with R, G and B components included in an RGB value of a neighboring pixel thereof to judge whether any component has a difference that is no less than a prescribed threshold, and extract the target pixel as a line-shaped noise pixel if at least one of the components has the difference and the line-shaped noise pixel constitutes a prescribed number or more of line-shaped noise pixels extending in a feeding direction of the sheet;
a corrector operable to correct the RGB value of the line-shaped noise pixel based on an RGB value of at least one of surrounding pixels included in a surrounding area of the line-shaped noise pixel; and
a correction canceller operable to generate color-difference signals based on the RGB value of the line-shaped noise pixel and the RGB values of the surrounding pixels included in the surrounding area of the line-shaped noise pixel respectively, calculate a color-deference level therebetween, and cancel correction of the RGB value of the line-shaped noise pixel if the color-difference level is less than a prescribed level.

8. An image reading method comprising:
a reading step of reading an image formed on a sheet to acquire RGB values of pixels that constitute the image, by using a sheet-through method;
a storing step of storing, in a storage, a plurality of combinations of an RGB value and a condition for line-shaped noise extraction corresponding thereto;
an extracting step of acquiring, from the storage, for each target pixel in the image, conditions corresponding to RGB values of surrounding pixels included in a surrounding area of the target pixel, and according to each of the acquired conditions, extracting the target pixel as a line-shaped noise pixel if the target pixel constitutes a series of line-shaped noise pixels extending in a feeding direction of the sheet; and
a correcting step of correcting an RGB value of the line-shaped noise pixel based on an RGB value of at least one of surrounding pixels included in a surrounding area of the line-shaped noise pixel.

9. The image reading method of claim 8, wherein
each of the conditions indicates thresholds for R, G and B components included in a corresponding RGB value, and
the extracting step compares R, G and B components included in the RGB value of the target pixel with R, G and B components included in an RGB value of a neighboring pixel thereof to judge whether any component has a difference that is no less than corresponding one of the thresholds indicated by conditions corresponding to the RGB values of the surrounding pixels included in the surrounding area of the target pixel, and extracts the target pixel as the line-shaped noise pixel if at least one of the components has the difference and a count of the series of line-shaped noise pixels is no less than a prescribed number.

10. The image reading method of claim 8, wherein
each of the conditions indicates a coring level for coring, and
the extracting step performs the coring on the RGB values of the pixels acquired by the reader, according to the coring level indicated by the conditions corresponding to the RGB values of the surrounding pixels included in the surrounding area of the target pixel, compares coring-result R, G and B components included in the RGB value of the target pixel with coring-result R, G and B components included in an RGB value of a neighboring pixel thereof to judge whether any component has a difference that is no less than a prescribed threshold, and extracts the target pixel as the line-shaped noise pixel if at least one of the components has the difference and a count of the series of line-shaped noise pixels is no less than a prescribed number.

11. The image reading method of claim 8, wherein
each of the conditions indicates thresholds for R, G and B components included in a corresponding RGB value, and a coring level for coring, and
the extracting step performs the coring on the RGB values of the pixels acquired by the reader, according to the coring level indicated by the conditions corresponding to the RGB values of the surrounding pixels included in the surrounding area of the target pixel, compares coring-result R, G and B components included in the RGB value of the target pixel with coring-result R, G and B components included in an RGB value of a neighboring pixel thereof to judge whether any component has a difference that is no less than corresponding one of the thresholds indicated by conditions corresponding to the RGB values of the surrounding pixels included in the surrounding area of the target pixel, and extracts the target pixel as the line-shaped noise pixel if at least one of the components has the difference and a count of the series of line-shaped noise pixels is no less than a prescribed number.

12. The image reading method of claim 9, wherein
the correcting step defines a plurality of blocks throughout the surrounding area of the line-shaped noise pixel by averaging R, G and B components among each prescribed number of pixels, extracts one of the blocks whose non-noise color component has a smallest difference from a non-noise color component of the line-shaped noise pixel, and corrects the RGB value of the line-shaped noise pixel by replacing with an RGB value of the extracted one of the blocks, where the non-noise color component is any component of the RGB value of the line-shaped noise pixel other than a noise color component, and the noise color component is a component that has the difference that is no less than the corresponding one of the thresholds indicated by the conditions corresponding to the RGB values of the surrounding pixels included in the surrounding area of the line-shaped noise pixel.

13. The image reading method of claim 8, wherein
the correcting step generates color-difference signals based on the RGB value of the line-shaped noise pixel and the RGB values of the surrounding pixels included in the surrounding area of the line-shaped noise pixel respectively, calculates a color-deference level therebetween, and cancels correction of the RGB value of the target pixel if the color-difference level is less than a prescribed level.

14. An image reading method comprising:
a reading step of reading an image formed on a sheet to acquire RGB values of pixels that constitute the image, by using a sheet-through method;
an extracting step of comparing R, G and B components included in an RGB value of each target pixel in the image with R, G and B components included in an RGB value of a neighboring pixel thereof to judge whether any component has a difference that is no less than a prescribed threshold, and extracting the target pixel as a line-shaped noise pixel if at least one of the components has the difference and the line-shaped noise pixel constitutes a prescribed number or more of line-shaped noise pixels extending in a feeding direction of the sheet;
a correcting step of correcting the RGB value of the line-shaped noise pixel based on an RGB value of at least one of surrounding pixels included in a surrounding area of the line-shaped noise pixel; and
a correction canceling step of generating color-difference signals based on the RGB value of the line-shaped noise pixel and the RGB values of the surrounding pixels included in the surrounding area of the line-shaped noise pixel respectively, calculating a color-deference level therebetween, and canceling correction of the RGB value of the line-shaped noise pixel if the color-difference level is less than a prescribed level.
